(19) United States
(12) Patent Application Publication
(10) Pub. No.: US 2011/0151115 A1
(43) Pub. Date: Jun. 23, 2011

(54) Apparatus And Methods For Dispensing Adhesive To Labels

(75) Inventor: Eric Lingier, Straelen (DE)

(73) Assignee: NORDSON CORPORATION, Westlake, OH (US)

(21) Appl. No.: 12/672,194

(22) PCT Filed: Aug. 6, 2008
(86) PCT No.: PCT/US08/72319

§ 371 Date: Feb. 4, 2010

Related U.S. Application Data
(60) Provisional application No. 60/954,111, filed on Aug. 6, 2007.

(51) Int. Cl. B05D 5/10; B05B 7/08

(52) U.S. Cl. 427/207.1; 118/314

(57) ABSTRACT

In one aspect, a labeling apparatus for applying a label onto a moving object includes a label delivery mechanism configured to hold the label and operable to deliver the label to the object. At least first plurality of electrically-actuated adhesive applicators is positioned and arranged to dispense adhesive onto the label such that the label may be adhered to the object. The first plurality of electrically-actuated adhesive applicators is arranged in a first row oriented in a direction transverse to a direction of travel of the label and is configured to dispense adhesive to define a first linear arrangement of dots on the label. Second and third pluralities of electrically-actuated adhesive applicators may be used with the first plurality of electrically-actuated adhesive applicators to obtain a desired adhesive arrangement.

This application claims the benefit of priority to U.S. Provisional Patent Application Ser. No. 60/954,111, filed Aug. 6, 2007 (expired), the disclosure of which is fully incorporated by reference.

### TECHNICAL FIELD

The present invention generally relates to the application of adhesive onto objects and, more particularly, to the application of adhesive onto labels in a packaging operation.

### BACKGROUND

Labels may be made in various sizes and shapes, and may further fall into one of several types. One type of label, for example, is the wrap-around label, in which a leading edge of the label is initially secured with adhesive to a three dimensional object, such as a container or other product or product packaging of any shape. The label is then wrapped around the object so that the trailing edge of the label overlaps and is adhesively secured to the label itself. Another type of label is one in which both the leading and trailing edges of the label are affixed directly to the object.

The securement of labels to bottles or other containers, for example, must be of such a quality that the labels can withstand the various conditions that may be later experienced by the containers or bottles during shipping, storage, and use thereof subsequent to the product packaging or filling operation. For example, with bottles of carbonated beverages, the labels must withstand expansion of the bottles due to the carbonation of the beverage and, for example, additional expansion and contraction during shipping and storage operations in which the temperatures of the product may vary. Moreover, the labels must also be aesthetically pleasing. For example, it may be desired that the exposed edge of a label should not readily flap, become detached from the product, have exposed adhesive, or have large amounts of adhesive forming lumps underneath the label.

In conventional processes, adhesive is applied to labels using a wheel coater. Wheel coaters use an open reservoir for holding the adhesive. A rotating wheel receives a coating of adhesive on its outer circumference that in turn transfers the adhesive onto the label by rolling contact with the label. A container, such as a bottle, can, or other type of object moves along a conveyor and a paper or plastic label is secured to the outer surface of the container or object during a production operation. A drawback of wheel-applied adhesive is that the open reservoir is susceptible to contamination, which may affect the quality of applied labels and lower the efficiency of the machine. Wheel coaters also require precise settings to ensure adequate results of dispensed labels. These settings must be adjusted and finely tuned each time the labels are changed.

There is a need for a manner of applying adhesive to either labels or containers, or both, in which the adhesive is applied in a non-contact fashion, but also with reduced needs for maintenance requirements and good adhesive coverage, while at the same time using a minimum amount of adhesive to secure a label to a container. There is also a need for increased control over the amount of adhesive that is applied, especially in applications where different amounts of adhesive are required for different portions of a label. There is also a need for a labeling apparatus that is capable of applying labels of various lengths and widths to containers.

### BRIEF DESCRIPTION OF THE DRAWINGS

FIG. 1 is a plan view of a back surface of a label, illustrating an adhesive pattern.

FIG. 2 is another plan view of a back surface of a label, illustrating another adhesive pattern.

FIG. 3 is another plan view of a back surface of a label illustrating another adhesive pattern.

FIG. 4 is a fragmented plan view of a back surface of a wrap-around label, illustrating first and second label portions having first and second adhesive patterns.

FIG. 5 is a plan view of an exemplary roll-fed labeling apparatus.

FIG. 5A is a plan view of another exemplary roll-fed labeling apparatus.

FIG. 5B is a plan view of a portion of a wrap-around label illustrating an adhesive pattern.

FIG. 5C is a perspective view of an arrangement of electrically-actuated dispensing guns of the apparatus of FIG. 5A.

FIG. 5D is a top plan view of the dispensing guns of FIG. 5C.

FIG. 6 is a plan view of a wrap-around label being dispensed from a roll.

FIG. 7 is a plan view of another exemplary roll-fed labeling apparatus.

FIG. 8 is a fragmented plan view of a back surface of another exemplary wrap-around label.

### DETAILED DESCRIPTION

FIGS. 1-4 illustrate various examples of adhesive patterns that may be applied to a leading edge portion 8 or a trailing edge portion 9 of a label 10 with apparatus to be further described below. The labels 10 are described in connection with methods and apparatus for application of labels to containers, however, it will be appreciated that the labels may be applied to any desired object. Adhesive may be applied to the labels in a pattern according to a specific application. For example, as shown in FIG. 1, adhesive applied to a label 10 may be spaced a distance “d” from an edge 12 thereof. The distance “d” may be chosen, for example, so as to preclude the adhesive from squeezing out from beneath the label 10 and being exposed when the label 10 is applied to a container.

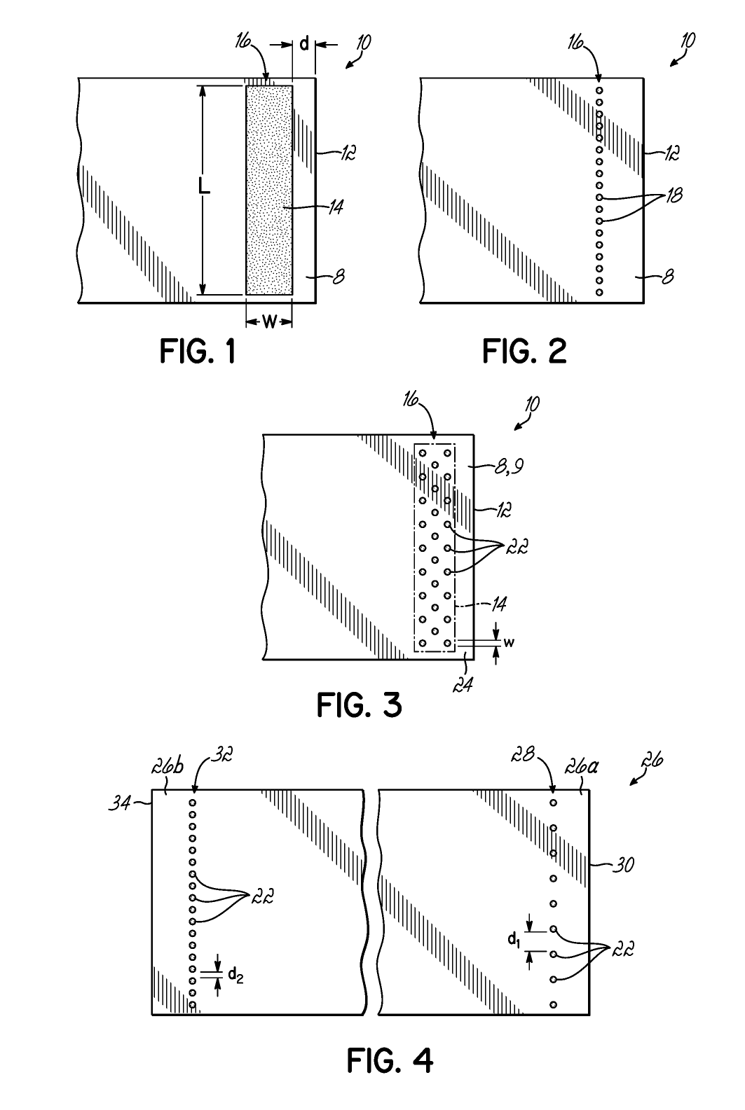

Additionally, adhesive may be applied within an overall adhesive pattern area 14 that approximates a lateral edge region 16 of the label 10. Thus, for labels having a rectangular appearance, the pattern area 14 may also be a rectangle having a length “L” and a width “W”. The adhesive may be applied to provide continuous coverage over the area 14 or may be applied to include a pattern, for example, defined by dots 18 dispensed in a linear pattern (FIG. 2) or defined by dots 22 applied in a staggered pattern (FIG. 3). The area 14 is defined by the outer boundaries of each applied adhesive pattern along the length “L” and width “W” of the pattern area 14.

Various adhesive patterns may be applied to one or both of the leading or trailing edge portions 8, 9 including beads, dots, filaments, or combinations thereof, or any other adhesive pattern. In one aspect, the adhesive in this region of label 10 may be fairly evenly distributed to eliminate peaks or valleys that may, for example, be readily visible to or readily felt by the consumer after the label 10 has been applied to a container.

In another embodiment, and as shown in FIG. 3, several dots 22 of adhesive are dispensed onto the leading and/or trailing edge portions 8, 9 of label 10 within the area 14. The dots 22 of adhesive may be sized, for example, such that the adhesive is able to readily adhere the corners of the label. To this end, the size and position of the dots 22 may be such that it ensures adhesive coverage of corner regions 24 of the label 10 to thereby prevent or minimize the occurrence of peeling edges or dog-ear corners. For example, and without limitation, a width “w” of dot 22 may be about 2 mm.

With reference to FIG. 4, a wrap-around label 26 includes, respectively, leading and trailing edge portions 26a, 26b having respective adhesive patterns that may be similar to or different from one another. In this exemplary embodiment, the wrap-around label 26 has a linear pattern 28 spaced from the leading edge 30 and defined by dots 22 spaced from one another by a distance d₁. Similarly, the label 26 includes a linear pattern 32 defined by dots 22 spaced from a trailing edge 34 of the label 10. The dots 22 of pattern 32, in this exemplary embodiment, are spaced from one another by a distance d₂ that is smaller than distance d₁. For example, and without limitation, the distance dᵢ may be about 1 inch while the distance d₂ may be about half an inch or about one third of an inch. Alternatively, and as noted above, the leading edge portion 26a may include any pattern of any form such as those described above in regard to FIGS. 1-3, or any other desired pattern. Similarly, the trailing edge portion 26b may include a pattern similar to that of leading edge portion 26a or any other pattern. Examples of patterns and apparatus to dispense adhesive in such patterns are described in U.S. patent application Ser. No. 11/426,074, assigned to the assignee of the present invention, the disclosure of which is incorporated by reference herein in its entirety.

Other patterns of adhesive beads or filaments that may be used include, but are not limited to: straight lines, sinusoidal patterns, omega-shaped patterns, or saw tooth patterns. When these or the above patterns are used, the amount of adhesive applied may be suitably chosen so as to prevent “read through” (i.e., the adhesive is not readily apparent from the outside of the label).

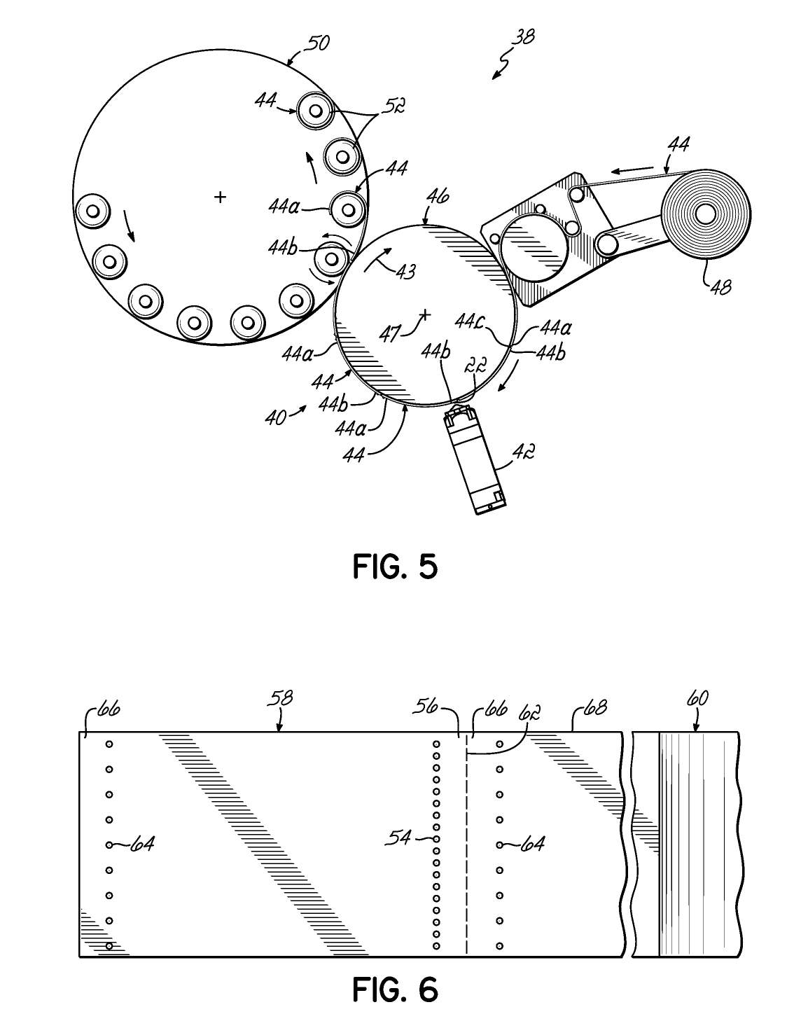

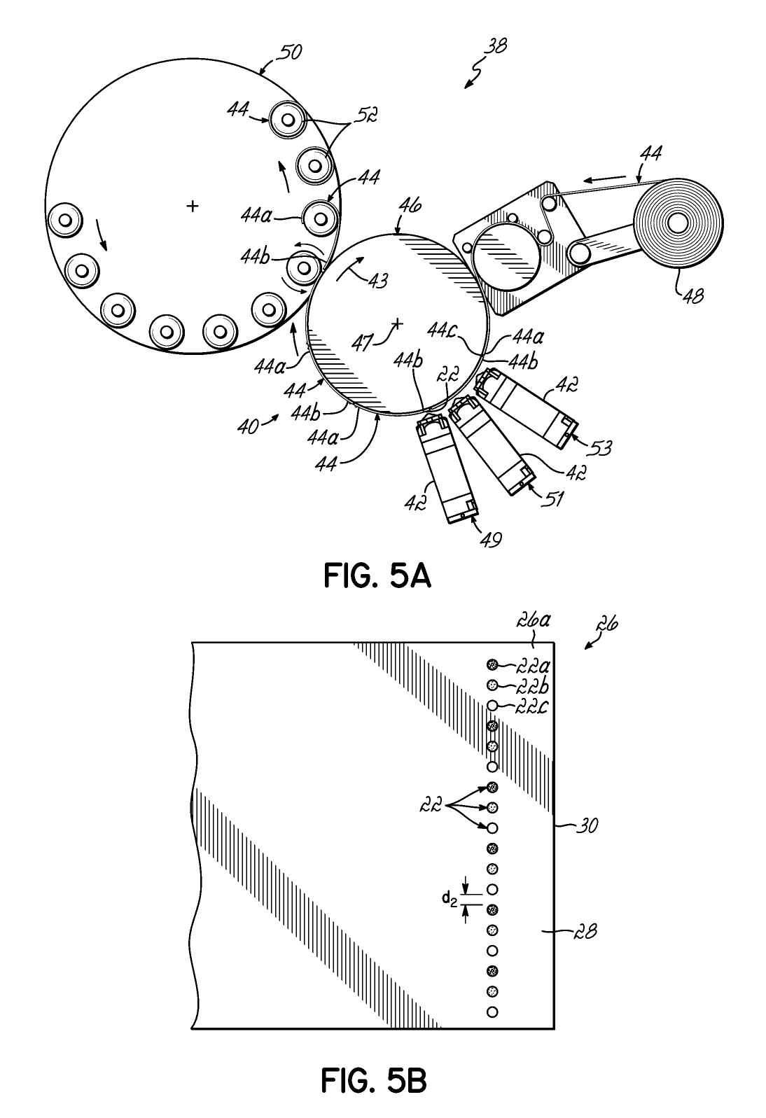

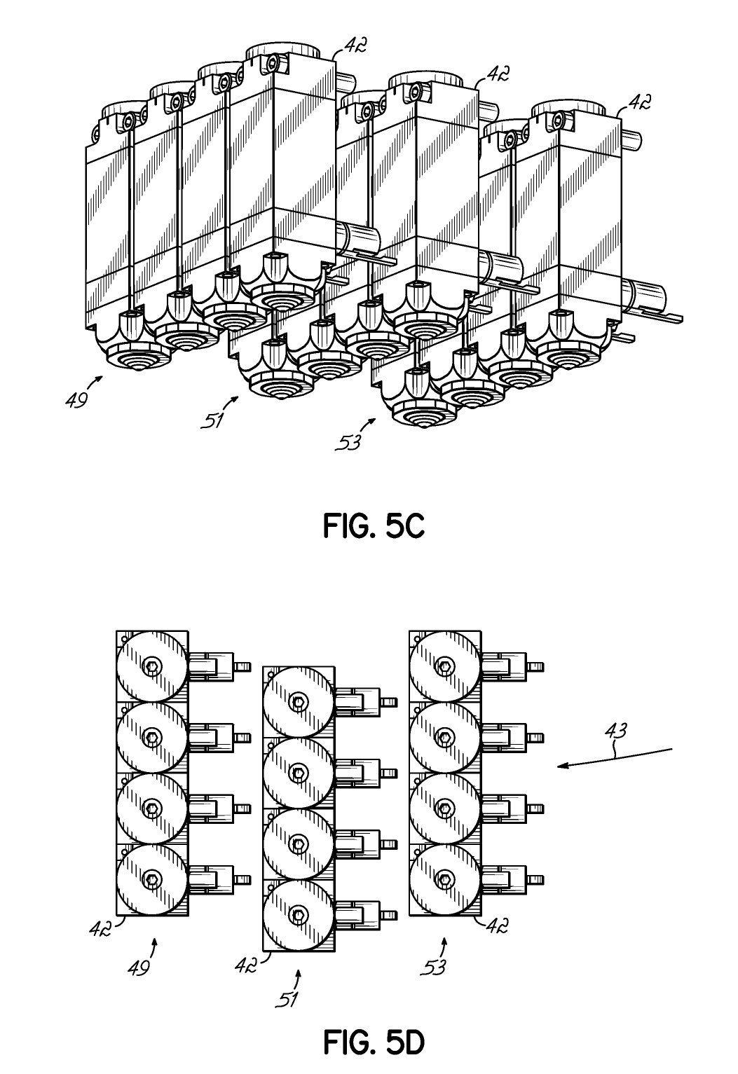

FIG. 5 shows an exemplary labeling apparatus 38 that may be used to create one or more of the adhesive patterns discussed above. Labeling apparatus 38 includes a label delivery mechanism 40 and one set of electrically-actuated adhesive applicators or dispensing guns 42 arranged to dispense dots 22 of adhesive in a linear pattern, similar to the patterns 28 or 32 of FIG. 4. To this end, the electrically-actuated dispensing guns 42 (only one shown in the view of FIG. 5) are arranged in a row generally transverse to the direction of travel (arrow 43) of the labels 44 i.e., in a direction orthogonal to the plane of the drawing sheet. As used herein, the term “electrically-actuated” refers to devices such as adhesive dispensing guns that use a current and an electro-magnetic coil to open and close a corresponding valve thereof to control flow of a liquid substance (e.g., adhesive) through the valve. The electrically-actuated dispensing guns 42 may, for example, be of the type commercially known under the tradename e.dot®, available from Nordson Corporation of Westlake, Ohio, the assignee of the present invention. As used herein, the term “electrically-actuated” may also refer to adhesive dispensing guns that utilize piezo-electric components to facilitate dispensing dots of liquid adhesive.

The label delivery mechanism 40 is configured to hold several labels 44 and is operable to deliver individual labels 44 to a conveyor, such as a carousel 50 having bottles or containers 52 positioned thereon. In the embodiment shown in FIG. 5, each electrically-actuated dispensing gun 42 is used to dispense adhesive to the labels 44 as they are held on a vacuum wheel or drum 46 of the delivery mechanism 40, which rotates about a center 47.

In the exemplary embodiment of FIG. 5, each electrically-actuated dispensing gun 42 intermittently applies adhesive to a leading edge portion 44a or trailing edge portion 44b of each label 44. More specifically, each electrically-actuated dispensing gun 42 is cycled on and off to dispense an adhesive pattern to the leading and trailing edge portions 44a, 44b of one label 44 and then is immediately cycled on and off again to dispense an adhesive pattern to the leading and trailing edge portions 44a, 44b of an adjacent label 44 located upstream on the vacuum drum 46. In one embodiment, cycling of each electrically-actuated dispensing gun 42 may be such that the electrically-actuated dispensing guns 42 cycle on and off to dispense dots 22 onto label 44 in a linear arrangement or pattern generally orthogonal to the direction of travel of the label 44 (arrow 43) as depicted generally in FIG. 2. Alternatively, cycling on and off may be such that the dots 22 are dispensed to define a non-linear arrangement as depicted generally in FIG. 3. Likewise, cycling on and off may be such that the dots 22 define a linear arrangement or pattern that is oriented at an acute angle relative to the direction of travel (arrow 43) of the label 44.

The labels 44 may be carried by the vacuum drum 46 as a continuous web. Alternatively, the labels 44 may be cut from a roll 48 while on the vacuum drum 46, thereby producing seams 44c between adjacent labels. The cycle time of each electrically-actuated adhesive gun 42 may be suitably chosen for the specific application. One application may include, for example, using adhesive having a viscosity in a range of about 280 centipoise to about 1200 centipoise. For example, and without limitation, a cycle time may be in the range of about 0.7 ms to about 1.1 ms. The intermittent operation of the electrically-actuated adhesive guns 42 therefore enables high production line speeds (i.e., travel of labels 44 around drum 46) while avoiding application of adhesive over the seam 44c between adjacent labels 44 or over the portion of the label 44 that will subsequently become the seam 44c. For example, labels may be applied to containers 52 at a rate greater than about 800 labels per minute, or at a rate greater than about 1000 labels per minute.

With reference to FIG. 5, dispensing of adhesive to a label 44 may be such that adhesive is applied adjacent the cut joint or seam 44c, on either or both sides of the cut joint 44c. Moreover, the application of adhesive may be such that adhesive is not applied over the cut joint 44c itself. That is, the adhesive may be applied to an area that is spaced from the leading or trailing edge defined by seam 44c by a distance “d” (FIG. 1). As noted above, the distance “d” may be chosen to preclude the adhesive from squeezing out from beneath the label 44 and being exposed when the label 44 is applied to the container 52.

In a subsequent step of the process depicted in FIG. 5, after the electrically-actuated dispensing guns 42 dispense adhesive, the labels are applied to the bottles or containers 52 positioned on the rotating carousel 50. The carousel 50 is positioned relative to the vacuum drum 46 such that the bottles 52 come into contact with the labels 44 after adhesive is applied. To facilitate applying the labels 44, the bottles 52 may be rotated in a direction opposite that of the vacuum drum 46. For example, with reference to FIG. 5, bottles 52 may be rotated in counter-clockwise directions, as indicated by the unlabeled arrows around bottle 52, while vacuum drum 46 is rotated in a clockwise direction, as indicated by arrow 43. It will be appreciated that other types of conveying devices may be used instead of a carousel, such as, and without limitation, various in-line conveyors.

With reference to FIGS. 5A-5D, the electrically-actuated dispensing guns 42 may be arranged in a staggered fashion. More particularly, the electrically-actuated dispensing guns 42 may be arranged in two or more adjacent rows of electrically-actuated dispensing guns 42. In the exemplary embodiment of FIG. 5A, the electrically-actuated dispensing guns 42 are arranged in three adjacent rows 49, 51, 53 of electrically-actuated dispensing guns 42, with each row 49, 51, 53 being oriented generally orthogonal to the direction of travel of the label 44 (arrow 43). Moreover, the electrically-actuated dispensing guns 42 are arranged such that any two adjacent electrically-actuated dispensing guns 42 are not aligned to one another in the direction of travel of the label 44 (FIG. 5D). In FIGS. 5A-5D, the manifolds and cord sets associated with dispensing guns 42 have been omitted for clarity.

In this regard, actuation of the electrically-actuated dispensing guns 42 is suitably chosen to dispense a pattern similar to that of pattern 32 of FIG. 4, as the label 44 moves sequentially past row 53, then row 51, and then row 49. In particular, the electrically-actuated dispensing guns 42 of row 53 dispense adhesive at a specific time T1 in the adhesive application process. This specific time corresponds to a point in the process where the target portion of label 44 (the portion that is to receive the adhesive) moves past row 53. The electrically-actuated dispensing guns 42 of row 51 dispense adhesive at a time T2 that is later than time T1 and which corresponds to a point in the process where the target portion of label 44 moves past row 51. Finally, the electrically-actuated dispensing guns 42 of row 49 dispense adhesive at a time T3 that is later than time T2 and which corresponds to a point in the process where the target portion of label 44 moves past row 49. Accordingly, actuation of the guns 42 of rows 49, 51, 53 result respectively in the dispensing of first, second, and third linear arrangements 22a, 22b, 22c of dots 22 (FIG. 5B).

With continued reference to FIGS. 5A-5D, the staggered arrangement of electrically-actuated dispensing guns enables the dispensing of a pattern of adhesive such that dots 22 defining such pattern are relatively close together. More particularly, the spacing of dots 22 produced by any one row 49, 51, 53 of electrically-actuated dispensing guns 42 may be limited by the amount of space occupied by each of the electrically-actuated dispensing guns 42. For example, the guns 42 may be configured such that the dots 22a, 22b, or 22c cannot be spaced closer than about one inch. In this regard, therefore, the staggered arrangement of electrically-actuated dispensing guns 42, best appreciated in FIGS. 5C-5D, may be such that the resulting adhesive pattern defined by the first, second, and third linear arrangements 22a, 22b, 22c of dots 22 jointly define a linear arrangement of dots 22 similar to pattern 32 (FIG. 4).

The staggered arrangement of electrically-actuated dispensing guns 42 similarly permits application of an arrangement of dots similar those defining the pattern of FIG. 3. In this regard, actuation of the electrically-actuated dispensing guns 42 of the first, second, and third rows 49, 51, 53 is suitably chosen to enable such arrangement. For example, and without limitation, the electrically-actuated dispensing guns 42 of all three of the rows 49, 51, 53 may be actuated at the same time. Alternatively, actuation may be chosen such that there is a delay between dispensing of adhesive from electrically-actuated dispensing guns 42 of one row relative to another.

In one aspect of the exemplary embodiment of FIGS. 5A-5D, the three-row arrangement of electrically-actuated dispensing guns 42 similarly permits application of a pattern similar to pattern 28 of FIG. 4 onto the leading or trailing edge portion 44a, 44b of label 44. More particularly, the electrically-actuated dispensing guns 42 may be configured such that only one of the rows 49, 51, 53 dispenses adhesive to a target portion of the label. For example, the electrically-actuated dispensing guns 42 may be configured such that all three rows 49, 51, 53 dispense adhesive onto trailing edge portion 44b, as described above, while only one of the rows 49, 51, 53 dispenses adhesive onto the leading edge portion 44a. In this regard, accordingly, the label 44 may receive a pattern of adhesive similar to pattern 28 (FIG. 4) on the leading edge portion 44a and a pattern similar to pattern 32 (FIG. 4) on the trailing edge portion 44b. Such an arrangement of dispensed adhesive may be desired, since the leading edge portion 44a of the label 44 is used only for initial pick-up by the bottle or container 52 and in many cases does not require as much adhesive as the trailing edge portion 44b where the label overlaps and is joined to the leading edge portion 44a.

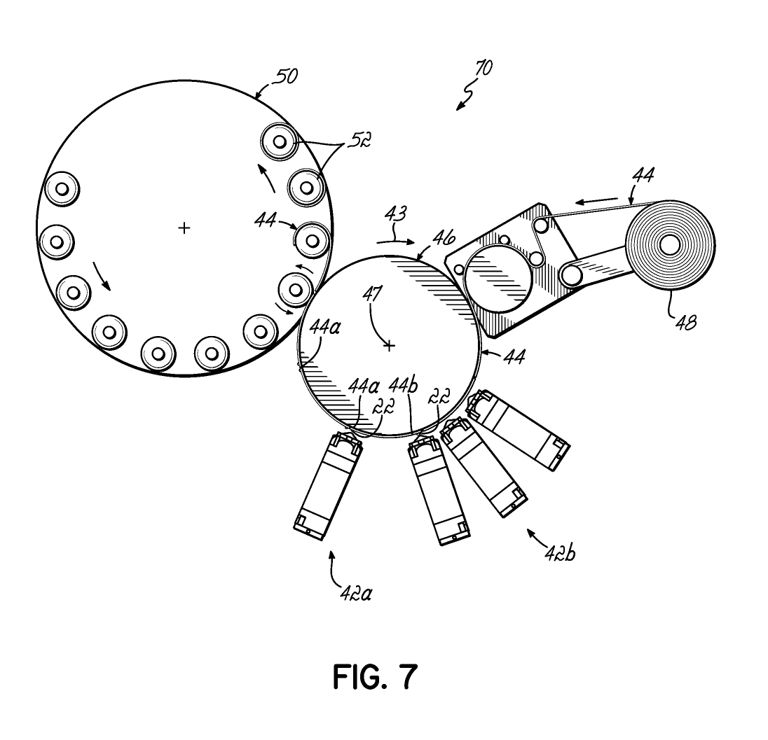

With reference to FIG. 6, in roll-fed labeling operations (such as the one shown in FIG. 5), adhesive 54 may be applied to a trailing edge 56 of a label 58 before or after the label is cut from a roll 60. The cut line is generally shown by reference numeral 62. Adhesive 64 may also be applied to a leading edge 66 of the next adjacent label 68. Dispensing of adhesive 54 and 64 on either side of the cut line 62 may occur before the first label 58 is cut from the roll 60 or it may take place after the cutting operation. Adhesive 54, 64 may be dispensed from a single electrically-actuated dispensing gun 42 or a single set of electrically-actuated dispensing guns 42. Alternatively, adhesive 54, 64 may be dispensed from at least two different electrically-actuated dispensing guns 42. Moreover, adhesive 54, 64 may be dispensed from at least two sets of electrically-actuated dispensing guns 42, as explained in further detail below with respect to the embodiment of FIG. 7.

With reference to FIG. 7, a labeling apparatus 70 includes two sets 42a, 42b of electrically-actuated dispensing guns 42 mounted adjacent the vacuum drum 46 for dispensing adhesive onto leading and trailing edge portions 44a, 44b of labels 44 dispensed from roll 60. The relative location of the two sets 42a, 42b of electrically-actuated dispensing guns 42 may be such that adhesive is simultaneously applied to the leading and trailing edge portions 44a, 44b. While this embodiment depicts two sets 42a, 42b of electrically-actuated dispensing guns 42 respectively dispensing adhesive onto the leading and trailing edge portions 44a, 44b, other labeling apparatus are contemplated that include only one of such sets 42a, 42b. More particularly, for example, a labeling apparatus may include a set of electrically-actuated dispensing guns 42 for dispensing adhesive onto one of the leading or trailing edge portions 44a, 44b and another type of applicator for dispensing adhesive onto the other edge portion. For example, and without limitation, one of the edge portions may receive adhesive from one or more contact-type adhesive applicators (e.g., a slot gun) or from a pneumatically-actuated non-contact adhesive applicator.

In one aspect of the embodiment of FIG. 7, a first set 42a of electrically-actuated dispensing guns 42 is arranged in a single row while the second set 42b is arranged in a staggered fashion as described above with reference to the embodiment of FIG. 5A. Accordingly, the first set 42a is configured to deliver dots 22 of adhesive in a pattern resembling that of pattern 28 of FIG. 4 (i.e., where the dots 22 are spaced by a distance d₁), while the second set 42b is configured to deliver dots 22 in a pattern similar to that of pattern 32 (FIG. 4).

Accordingly, the amount and/or basis weight of adhesive dispensed onto the leading edge portion 44a may be different from the amount and/or basis weight dispensed onto the trailing edge portion 44b. In some applications it may be desirable, for example, to dispense a relatively high amount and/or basis weight of adhesive onto the trailing edge portion 44b of the label 44 relative to the leading edge portion 44a. In such applications, accordingly, dispensing of adhesive is facilitated by the exemplary arrangement of the embodiment of FIG. 7.

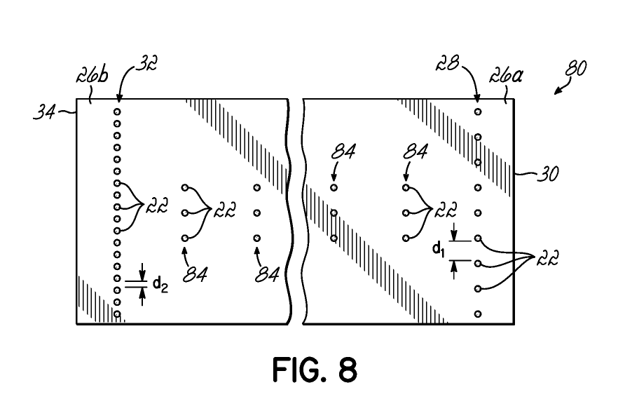

While the embodiments discussed above have shown and described adhesive dispensed to only the leading and trailing edge portions 44a, 44b of a label 44, it may be desirable to dispense adhesive to portions of a label 44 intermediate the leading and trailing edge portions 44a, 44b. For example, it may be desirable to dispense adhesive to intermediate portions of a label to provide a tactile feel to the label that facilitates gripping the bottle or container 52 to which the label is applied. In this case, the adhesive dots do not only serve to adhere the label to the bottle, but also provide a grip. FIG. 8 depicts another embodiment of a label 80, similar to the label 26 shown and described above with respect to FIG. 4, wherein like features are similarly numbered. Label 80, however, includes an intermediate portion 82, between the leading edge portion 26a and trailing edge portion 26b, having dots of adhesive 22 applied at intervals along the length of the label 80. While this embodiment depicts adhesive 22 applied in rows 84 spaced apart along the length of the label 80, it will be appreciated that various other arrangements and configurations of adhesive 22 may be applied to the intermediate portion 82 of label 80 to provide such tactile feel.

While the above embodiments have been described including electrically-actuated dispensing guns 42, each dispensing one dot 22 of adhesive, it is contemplated that electrically-actuated dispensing guns may be configured to dispense adhesive in other patterns. For example, and without limitation, an electrically-actuated dispensing gun may be configured to dispense an array or pattern of dots rather than a single dot 22. Accordingly, a labeling apparatus may include a single electrically-actuated dispensing gun rather than a set of electrically-actuated dispensing guns 42 arranged in one or more rows.

Persons of ordinary skill in the art will readily appreciate that any of the features described above for any of the embodiments may be combined with any of the features of any other embodiment. For example, and without limitation, an apparatus may include two single rows of electrically-actuated dispensing guns 42 dispensing adhesive to one or both of the leading and trailing edge portions of a label. Similarly, while the staggered arrangement of electrically-actuated dispensing guns 42 was described as dispensing adhesive in a pattern similar to the pattern 32 (FIG. 4) to a trailing edge portion of a label, it is contemplated that such pattern may alternatively or in addition be dispensed onto the leading edge portion or any other portion of the label.

While the present invention has been illustrated by the description of one or more embodiments thereof, and while the embodiments have been described in considerable detail, they are not intended to restrict or in any way limit the scope of the appended claims to such detail. The various features described herein may be utilized alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A labeling apparatus for applying a label onto a moving object, comprising:
a label delivery mechanism configured to hold the label and operable to deliver the label to the object; and
a first plurality of electrically-actuated adhesive applicators positioned and arranged to dispense adhesive therefrom onto the label as the label moves past said first plurality of electrically-actuated adhesive applicators;
said first plurality of electrically-actuated adhesive applicators arranged in a first row oriented in a direction transverse to a direction of travel of the label and configured to dispense adhesive to define a first linear arrangement of adhesive dots on the label.

2. The labeling apparatus of claim 1, further comprising:
a second plurality of electrically-actuated adhesive applicators arranged in a second row oriented in a direction transverse to the direction of travel of the label and configured to dispense adhesive to define a second linear arrangement of adhesive dots on the label such that the second linear arrangement is generally co-linear with the first linear arrangement, thereby defining a linear pattern.

3. The labeling apparatus of claim 2, wherein said first and second pluralities of electrically-actuated adhesive applicators are configured to sequentially dispense adhesive to the label.

4. The label apparatus of claim 2, wherein a first applicator of said first plurality is offset in the direction of travel from a second applicator of the second plurality that is adjacent said first applicator.

5. The labeling apparatus of claim 2, wherein said first plurality of electrically-actuated adhesive applicators dispenses adhesive to first and second portions of the label, and said second plurality of electrically-actuated adhesive applicators dispenses adhesive only to the first portion of the label.

6. The labeling apparatus of claim 2, further comprising:
a third plurality of electrically-actuated adhesive applicators arranged in a third row oriented in a direction transverse to the direction of travel of the label and configured to dispense adhesive to define a third linear arrangement of adhesive dots on the label such that the third linear arrangement is generally co-linear with the first and second linear arrangements.

7. A method of dispensing adhesive onto a label moving in a travel direction, the method comprising:
moving the label past a first plurality of electrically-actuated adhesive applicators;
applying a first linear arrangement of adhesive dots on the label with the first plurality of electrically-actuated adhesive applicators at a first time;
moving the label past a second plurality of electrically-actuated adhesive applicators positioned adjacent the first plurality of electrically-actuated adhesive applicators; and
applying a second linear arrangement of adhesive dots on the label with the second plurality of electrically-actuated adhesive applicators at a second time that is later than the first time, the second linear arrangement being co-linear with the first linear arrangement to thereby define a linear pattern.

8. The method of claim 7, further comprising:
moving the label past a third plurality of electrically-actuated adhesive applicators positioned adjacent the second plurality of electrically-actuated adhesive applicators; and
applying a third linear arrangement of adhesive dots on the label with the third plurality of electrically-actuated adhesive applicators at a third time that is later than the second time, the third linear arrangement being co-linear with the first and second linear arrangements to thereby define a second linear pattern.

9. A method of dispensing adhesive onto a label, comprising:
moving a first portion of the label past a first plurality of electrically-actuated adhesive applicators;
applying a first linear arrangement of dots on the first portion with the first plurality of electrically-actuated adhesive applicators;
moving the first portion of the label past a second plurality of electrically-actuated adhesive applicators;
applying a second linear arrangement of dots on the first portion with the second plurality of electrically-actuated adhesive applicators, the second linear arrangement being co-linear with the first linear arrangement, thereby defining a linear pattern;
moving a second portion of the label past the first plurality of electrically-actuated adhesive applicators;
applying the first linear arrangement of dots on the second portion with the first plurality of electrically-actuated adhesive applicators; and
moving the second portion of the label past the second plurality of electrically-actuated adhesive applicators without applying adhesive from the second plurality of electrically-actuated adhesive applicators on the second portion.

10. The method of claim 9, further comprising:
moving the first portion of the label past a third plurality of electrically-actuated adhesive applicators; and
applying a third linear arrangement of dots on the first portion with the third plurality of electrically-actuated adhesive applicators, the third linear arrangement being co-linear with the first and second linear arrangements to thereby define a second linear pattern.

11. The method of claim 9, further comprising:
applying dots of adhesive along portions of the label intermediate the first and second portions.
